(19) United States
(12) Patent Application Publication
(10) Pub. No.: US 2015/0319702 A1
(43) Pub. Date: Nov. 5, 2015

(54) CONFIGURATION OF UPLINK OPEN LOOP POWER CONTROL PARAMETERS

(71) Applicant: QUALCOMM Incorporated, San Diego, CA (US)

(72) Inventors: Chirag Sureshbhai Patel, San Diego, CA (US); Vinay Chande, San Diego, CA (US); Liwen Yu, San Diego, CA (US); Tamer Adel Kadous, San Diego, CA (US)

(73) Assignee: QUALCOMM INCORPORATED, San Diego, CA (US)

(21) Appl. No.: 14/268,173

(22) Filed: May 2, 2014

(51) Int. Cl. H04W 52/14

(52) U.S. Cl. CPC H04W 52/146; H04W 52/242

(57) ABSTRACT

A method or apparatus for configuring OLPC parameters for uplink communications in a cellular wireless network includes determining an estimated number of neighbor cells deployed within radio range of a cell, and configuring OLPC parameters for uplink communications, based on the estimated number of neighbor cells. Determining the estimated number of neighbor cells may include measuring respective signal strengths of the neighbor cells using network listen functionality. At least two OLPC intermediate parameters Pₒ and α may be selected from a data table, based on the estimated number of neighbor cells. A path loss statistic may be determined, based on UE measurement reports including path losses of UEs to itself and other cells. The OLPC parameters may be selected based on the path loss statistic and Pₒ and α, and/or adapted based on at least one of UE power headroom reports or overload indicators received from the neighbor cells.

### BACKGROUND

Aspects of the present disclosure relate generally to wireless communication systems, and more particularly, to open loop power control (OLPC) in wireless networks.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station. A base station may be, or may include, a macrocell or small cell. Small cells may often be deployed without central planning. In contrast, macrocells are typically installed at fixed locations as part of a planned network infrastructure, and cover relatively large areas.

The 3rd Generation Partnership Project (3GPP) Long Term Evolution (LTE) advanced cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs.

One aspect of cellular network concerns uplink power control. For optimal performance, each UE should transmit at a power level that is no greater than necessary to efficiently communicate with the base station, for several reasons. Such reasons may include, for example, optimizing uplink (UL) capacity, power conservation, minimizing radio interference, and minimizing emitted radiation. Power control methods may include closed-loop power control, open-loop power control, and combinations thereof. In closed-loop power control, the UE modulates uplink transmission power in response to power feedback from the base station and/or neighboring UEs and base stations. “Power feedback” means feedback information specifically indicating a power level at which the UE should transmit, for example, an absolute power level, or an upward or downward increment from a current or baseline power level. In open-loop power control, the UE modulates uplink transmission power without power feedback.

Use of the shared Random Access Channel (RACH) by UEs initiating a network connection creates a potential for interference between competing UEs. Closed-loop power control using network feedback is useful for minimizing interference, but power feedback is not available for unconnected UEs attempting to initiate a connection using the RACH, due to being in an unconnected state. When the UE is in an unconnected state with respect to a base station, the base station does not allocate resources for communicating with the UE. Therefore, the base station cannot provide any UE-specific information to the UE, and may be unaware of the UE's existence. However, the UE may be able to detect certain control signals from the base station, for example, a Common Pilot Channel (CPICH) signal, while unconnected. An OLPC protocol enabling power control without power feedback may be used to minimize UL interference, at times when the UE is unconnected to the base station.

Using OLPC, a UE determines an initial transmit power for RACH access based on predetermined factors, for example, a difference between the primary Common Pilot Channel (CPICH) power and CPICH Received Signal Code Power (RSCP), plus an UL interference adjustment and a constant value. The UE then transmits a test preamble at the initial transmit power, and waits for an answer from the base station. If no answer is received, the UE increases the transmit power by an increment, and retransmits. This process can be repeated until an answer is received from the base station, until timeout, or until the UE reaches maximum transmit power without success.

OLPC parameters may be set via an Operations and Maintenance (OAM) function of the base station (e.g., eNB). Such OLPC parameters may be static for prolonged periods (e.g., greater than a day), and may therefore be referred to herein as “long-term” OLPC parameters.

OLPC parameters used for determining an initial transmit power and power increments should be chosen such that out-of-cell UL interference is minimized, to boost network capacity and edge user data rates. These objectives may become especially important in network environments including ad-hoc (unplanned) deployments of small cells. Traditional OAM-based parameter setting is unlikely to provide optimal performance in such environments, and more robust OLPC parameter-setting methods are therefore desirable.

### SUMMARY

Methods, apparatus and systems for open loop power control in wireless networks are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect, a network entity may perform a method for configuring OLPC parameters for uplink communications in a cellular wireless network. In an aspect, the OLPC parameters may be long-term parameters. The method may include determining, by a cell, an estimated number of neighbor cells deployed within radio range of the cell. As used herein, “within radio range” of a cell means geographically close enough to communicate wirelessly with the cell using radio signals. The method may include configuring OLPC parameters for uplink communications, based on the estimated number of neighbor cells.

In an aspect of the method, determining the estimated number of neighbor cells may include measuring respective signal strengths of the neighbor cells using a network listen functionality. The method may include selecting at least two OLPC intermediate parameters Pₒ, a nominal power level that is common for all UEs in the cell and α, a UE-specific fractional path-loss compensation factor, from a data table, based on the estimated number of neighbor cells. For example, the method may include determining a path loss statistic based on UE measurement reports including path losses of UEs to itself and other cells. In addition, the method may include selecting the OLPC parameters further based on the path loss statistic and the OLPC intermediate parameters Pₒ and α.

In another aspect, the method may include adapting the OLPC parameters based on the estimated density of the small cell deployment. This may include, for example, determining whether to change OLPC parameter based at least in part on an estimated density of small cell deployment in the neighborhood. As used herein, deployment “density” means a numeric count of neighbor cells per unit geographical area. The geographical locations of neighbor cells may be obtained via Global Positioning System (GPS) modules in the neighbor cells, if available, or by any other suitable method.

In another aspect, the method may include adapting the OLPC parameters based on at least one of UE power headroom reports or OIs (overload indicators) received from the neighbor cells.

In another aspect, the cell configuring the OLPC parameters may be, or may include, a small cell. In another aspect the neighbor cells may be, or may include, small cells.

In related aspects, a wireless communication apparatus may be provided for performing any of the methods and aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by equipment such as a mobile entity, for example a mobile entity or access terminal. In other embodiments, aspects of the technology may be embodied in a network entity, such as, for example, a small cell (e.g., pico cell, femto cell or Home Node B), a base station, or eNB. In some aspects, a mobile entity and network entity may operate interactively to perform aspects of the technology as described herein. Similarly, an article of manufacture may be provided, including a computer-readable storage medium holding encoded instructions, which when executed by a processor, cause a network entity or access terminal to perform the methods and aspects of the methods as summarized above.

### BRIEF DESCRIPTION OF THE DRAWINGS

FIG. 1 is a block diagram conceptually illustrating an example of a telecommunications system.

FIG. 2 is a block diagram conceptually illustrating an example of a small cell environment in which adaptive OLPC parameters are selected.

FIG. 3 is a block diagram conceptually illustrating a design of a base station/eNB and a UE configured according to one aspect of the present disclosure.

FIG. 4-6 illustrates aspects of a methodology for adapting long-term uplink OLPC parameters based on a small cell neighborhood.

FIG. 7 illustrates an embodiment of an apparatus for adapting long-term uplink OLPC parameters based on a small cell neighborhood, in accordance with the methodology of FIGS. 4-6.

### DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

New approaches may include self-configuration of long-term OLPC parameters for wireless network environments including unplanned small cell deployments. These approaches may include small cell deployments wherein each small cell chooses OLPC parameters based on a radio-frequency (RF) environment in its vicinity. This approach may be adapted for use with macro cells and other nodes for heterogeneous deployments.

A typical OLPC algorithm may include, among other things, two parameters: Pₒ and alpha, wherein Pₒ is an open loop adjustment factor and alpha is a fractional path loss compensation factor. For example, an OLPC algorithm may be expressed as:

P_{OL}=min[Pₘₐₓ,Pₒ+10 log 10(N_{RB})+αPL,

wherein POL is the open loop power, Pmax is a maximum allowable power for the UE, PL is the path loss from the base station measured by the UE, and N_{RB} is a generally constant number of resource blocks assigned to each transmission time interval (TTI). The present method calls for, in general, adapting these parameters as function of small cell deployment density to optimize performance. As small cell density increases, path loss between the UE and its serving cell is expected to diminish and UL interference statistics at serving cell also changes. To optimize long-term OLPC parameter settings for these characteristics, self-configuration of these OLPC parameters may be performed as described below. The small cell may provide OLPC parameters to unconnected UEs within radio range, using any suitable method, for example broadcasting. As used herein, “within radio range” of a cell means geographically close enough to communicate wirelessly with the cell using radio signals.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. The cdma2000 technology is covered by IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). The cdma2000 and UMB technologies are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

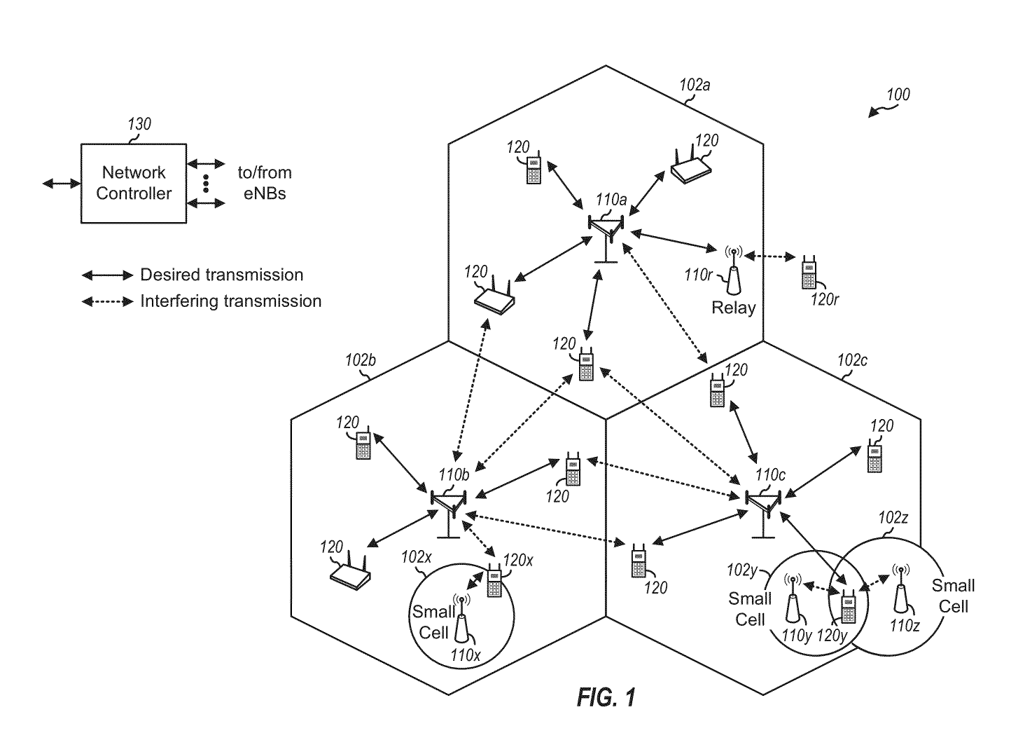

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, or small cell (e.g., a pico cellor a femto cell), and/or other types of cell. A macro cell may cover a relatively large geographic area (e.g., several kilometers in radius) and may allow unrestricted access by UEs with service subscription. Some types of small cell, for example, pico cells, may cover a relatively small geographic area and may allow unrestricted access by UEs with service subscription. Other types of small cells, for example, femto cells, may cover a relatively small geographic area (e.g., a home) and may allow restricted access by UEs having association with the small cell (e.g., UEs in a Closed Subscriber Group (CSG), UEs for users in the home, etc.). An eNB for a macro cell may be referred to as a macro eNB. An eNB for a small cell may be referred to as a small cell eNB. In the example shown in FIG. 1, the eNBs 110a, 110b and 110c may be macro eNBs for the macro cells 102a, 102b and 102c, respectively. The eNB 110x may be a small cell eNB for a small cell 102x. The eNBs 110y and 110z may be small cell eNBs for the small cells 102y and 102z, respectively. An eNB may support one or multiple (e.g., three) cells. As used herein, a small cell means a cell characterized by having a transmit power substantially less than each macro cell in the network with the small cell, for example low-power access nodes such as defined in 3GPP Technical Report (T.R.) 36.932 section 4.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, small cell eNBs, relays, etc. These different types of eNBs may have different transmit power levels, different coverage areas, and different impact on interference in the wireless network 100. For example, macro eNBs may have a high transmit power level (e.g., 5 to 20 Watts) whereas small cell eNBs and relays may have a lower transmit power level (e.g., 0.1 to 2 Watts).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, a smart phone, etc. A UE may be a cellular phone, a personal digital assistant (PDA), a wireless modem, a wireless communication device, a handheld device, a laptop computer, a cordless phone, a wireless local loop (WLL) station, or other mobile entities. A UE may be able to communicate with macro eNBs, small cell eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

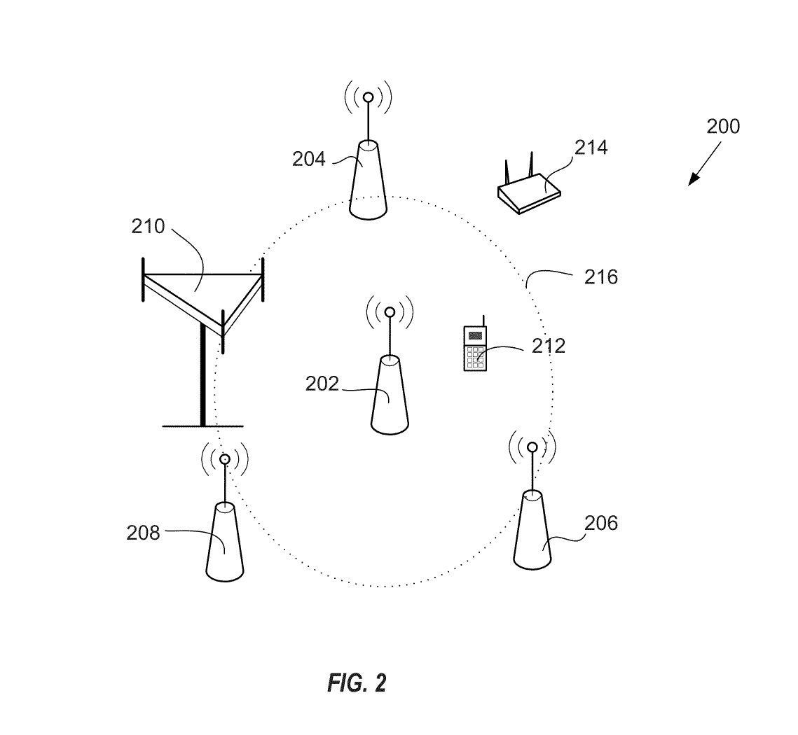

FIG. 2 shows a small cell neighborhood 200 in which adaptive OLPC parameters may be determined by a small cell 202. The neighborhood 200 may include an unknown, unplanned, and variable number of neighbor small cells 204, 206, 208, and one or more macro cells 210. One or more UEs 212, 214 may connect to a wireless network including the neighborhood 200 via the small cell 202.

A small cell 202 may indirectly estimate nearby small cell deployment density by measuring signal strength of neighbor small cells using Network Listen functionality 216. The measurements may be in the form of RSSI or RSRP of a small cell or a function of these quantities of several cells (e.g., sum of RSRP of several detected cells), or similar measure.

Based on these measured quantities, the small cell 202 may choose OLPC parameters based on a look-up table. For example, based on the RSRP exceeding some defined threshold, or being between defined values, the small cell may choose at least two OLPC parameters Pₒ and α from a corresponding row of a data table.

In addition, each serving small cell may through UE measurement reports collect statistics such as path loss of UEs to itself and other cells.

Then, the small cell may select OLPC parameters as some function of these path loss statistics and the OLPC parameters Pₒ and α. For example, if the small cell determines that the 90^{th} percentile path loss is within a predetermined increment of ‘X’, then it may select OLPC parameters Pₒ and α based on its determination, wherein ‘X’ is some defined baseline or threshold value of the path loss of OLPC parameters, as appropriate.

Further, the small cell may adapt the OLPC parameters based on UE power headroom reports, OI (overload indicator) received from other small cells 204, 206, 208 over a backhaul, or other factors. For example, if the small cell receives frequent OIs from neighbor small cell(s), it may gradually adapt OLPC parameters such that interference to the neighbor small cell(s) is minimized and the OIs received no longer indicate UL interference issues. This may be accomplished, for example, by reducing the parameter α, or by reducing the parameter Pₒ, or by reducing both α and Pₒ.

In the alternative, or in addition, the small cell may adapt the OLPC parameters based on the estimated density of the small cell deployment. This may include, for example, determining whether to change OLPC parameter based at least in part on an estimated density of small cell deployment in the neighborhood. The geographical locations of neighbor cells may be obtained via GPS modules in the neighbor cells, if available, or by any other suitable method. The small cell may use GPS information from small cell neighbors to obtain a measure of deployment density as a numeric count of neighbor cells per unit geographical area.

Accordingly, long-term OLPC parameter selection by a small cell or macrocell may be optimized for an environment including unplanned small cell deployments.

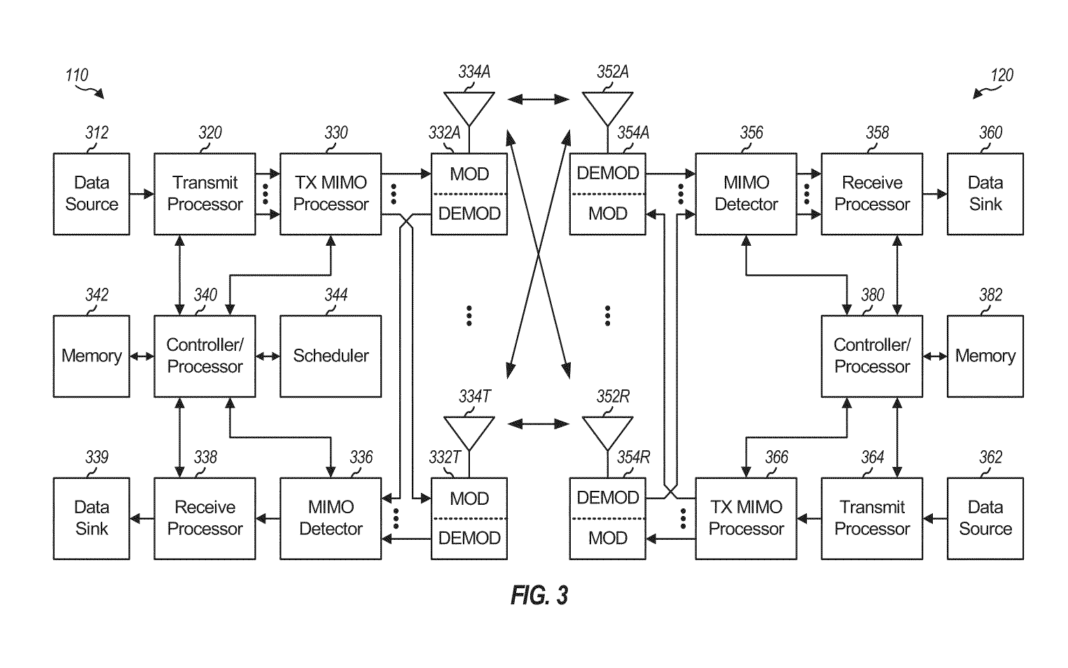

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

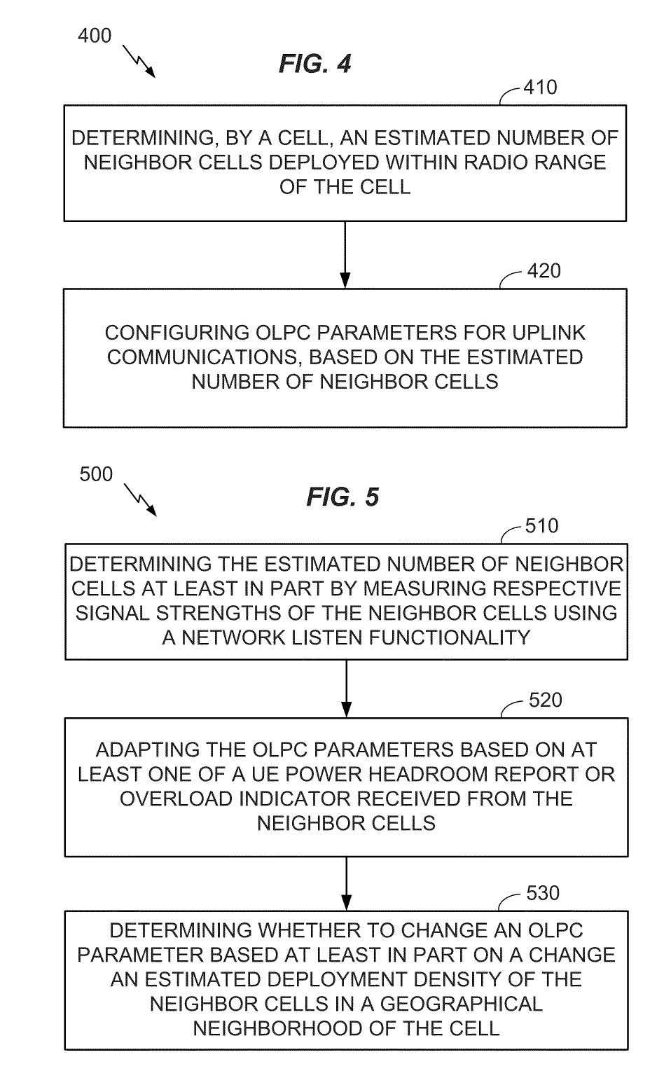

The controllers/processors 340 and 380 may direct the operation at the base station 110 and the UE 120, respectively. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

### Example Methodologies and Apparatus

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored as encoded instructions and/or data on an article of manufacture to facilitate transporting and transferring such methodologies to various devices. Those skilled in the art will understand and appreciate that a method could alternatively be represented as a series of interrelated states or events, such as in a state diagram.

FIG. 4 shows a method 400 for adapting a long-term ABS configuration of a cell. The cell may be in a neighborhood including one or more small cells comprising low power base stations of a wireless communications network. The cell may be a macrocell, or a small cell. The method 400 may include, at 410, determining, by the cell, an estimated number of neighbor cells deployed within radio range of the cell. For example, the cell may increment a count of detected neighbor cells based on each detection event wherein the cell detects a neighbor cell. The estimated number of neighbor cells may be a number selected from zero, one, or a plural number, in each case indicating how many neighbor cells are within radio range. A detection event may be enabled via a Neighbor Listen module, receiving measurement reports from UEs, or receiving reports from small cell neighbors via a backhaul. Determining the neighbor cell configuration state 410 may be repeated periodically, for example, hourly or daily. In addition, or in the alternative, determining the neighbor cell configuration state 410 may be triggered by a predefined event, for example a power-up event or detection of a new beacon, interference, or other signal from or related to the cell's radio neighborhood.

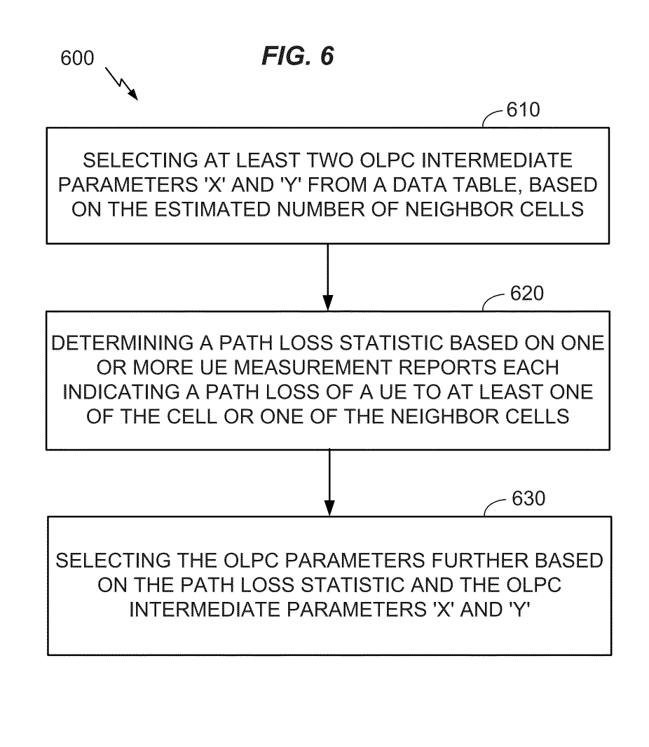

The method 400 may further include, at 420, configuring OLPC parameters for uplink communications, based on the estimated number of neighbor cells. This may include, for example, setting the UE's OLPC parameters Po and α using lookup table and algorithm as described, for example, in connection with FIG. 6 below. The method may include providing the OLPC parameters to a UE, for example in a periodic broadcast operation detectable by an unconnected UE.

The method 400 may include any one or more of the additional operations 500 or 600 illustrated in FIGS. 5-6. The operations shown in FIGS. 5-6 may not be required to perform the method 400. Operations 500, 600 are independently performed and not mutually exclusive. Therefore any one of such operations may be performed regardless of whether another downstream or upstream operation is performed. If the method 400 includes at least one operation of FIGS. 5-6, then the method 400 may terminate after the at least one operation, without necessarily having to include any subsequent downstream operation(s) that may be illustrated.

The method 400 may include, at 510, determining the estimated number of neighbor cells at least in part by measuring respective signal strengths of the neighbor cells using a network listen functionality. For example, the cell may count a number of neighbor cells for which a reference signal exceeding a certain threshold can be detected. For further example, the small cell may use GPS information from small cell neighbors to obtain a measure of deployment density as a numeric count of neighbor cells per unit geographical area. The method 400 may further include, at 520, adapting the OLPC parameters based on at least one of a UE power headroom report or overload indicator (01) received from the neighbor cells. For example, if the small cell receives one or more OI reports within a period of time, the cell may adjust the OLPC parameters downwards until fewer or no OI reports are received in the same amount of time. In other words, the cell may reduce OLPC parameters until a frequency of OI reports is reduced to zero or to some non-zero acceptable frequency. In an alternative, or in addition, the method 400 may further include, at 530, adapting the OLPC parameters based on the estimated density of the small cell deployment. This may include, for example, determining whether to change an OLPC parameter based at least in part on an estimated density of small cell deployment in the neighborhood, for example, based on a change in the estimated deployment density. For example, the small cell may determine to change one or more of the OLPC parameters based on an increase in the deployment density, or based on a decrease in the deployment density. The amount by which the small cell changes the parameters may be related to the amount and/or direction of change in the deployment density. The small cell may obtain geographical locations of neighbor cells via GPS modules in the neighbor cells, if available, or by any other suitable method.

In another aspect illustrated by FIG. 6, the method 400 may include, at 610, selecting at least two OLPC intermediate parameters Pₒ and α from a data table, based on the estimated number of neighbor cells. The estimated number of neighbor cells may be one of zero, one, or a plural number. The method may further include, at 620, the cell determining a path loss statistic based on one or more UE measurement reports each indicating a path loss of a UE to at least one of the cell or one of the neighbor cells. The method may include, at 630, selecting the OLPC parameters further based on the path loss statistic and the OLPC intermediate parameters Pₒ and α.

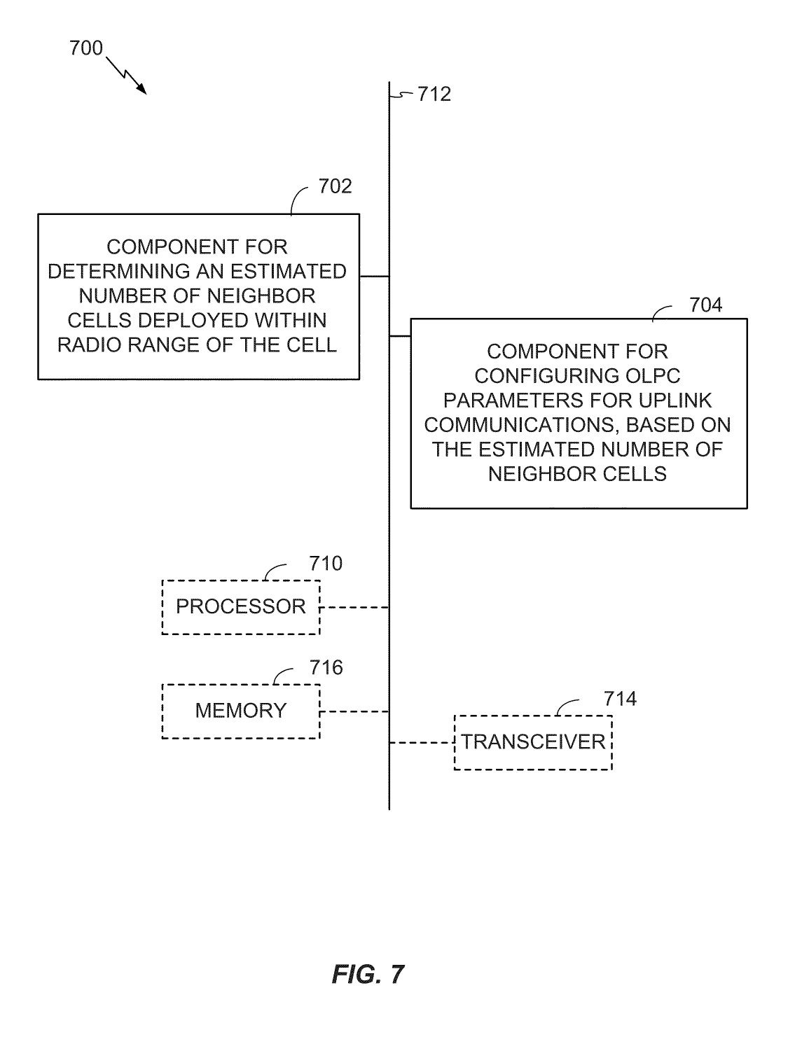

For further example, with reference to FIG. 7, there is depicted an apparatus 700 that may be configured as a cell in a wireless network, or as a processor or similar device for use within the cell, disposed as an aggressor cell. The apparatus 700 may include functional blocks that can represent functions implemented by a processor, software, hardware, or combination thereof (e.g., firmware).

As illustrated, in one embodiment, the apparatus 700 may include an electrical component or module 702 for determining an estimated number of neighbor cells deployed within radio range of the cell. For example, the electrical component 702 may include at least one control processor coupled to a transceiver or the like and to a memory with instructions for detecting a number of neighbor cells transmitting a reference signal above a designated level. The component 702 may be, or may include, a means for determining an estimated number of neighbor cells deployed within radio range of the cell. Said means may include the control processor executing any one or more of the algorithms for determining an estimated number of neighbor cells. The algorithm may include, for example, measuring reference signals from neighbor cells, and counting a number of neighbor cells transmitting a reference signal above a specific threshold, or other operations as described above in connection with FIG. 5.

The apparatus 700 may include an electrical component 704 for configuring OLPC parameters for uplink communications, based on the estimated number of neighbor cells. For example, the electrical component 704 may include at least one control processor coupled to a transceiver or the like and to a memory holding instructions for setting OLPC parameters using a algorithm based on the number of neighbor cells and optionally other inputs. The component 704 may be, or may include, a means for configuring OLPC parameters for uplink communications, based on the estimated number of neighbor cells. Said means may include the control processor executing any one or more of the algorithms for determining OLPC parameters as described above in connection with FIG. 6.

In related aspects, the apparatus 700 may optionally include a processor component 710 having at least one processor, in the case of the apparatus 700 configured as a network entity. The processor 710, in such case, may be in operative communication with the components 702-704 or similar components via a bus 712 or similar communication coupling. The processor 710 may effect initiation and scheduling of the processes or functions performed by electrical components 702-704. The processor 710 may encompass the components 702-704, in whole or in part. In the alternative, the processor 710 may be separate from the components 702-704, which may include one or more separate processors.

In further related aspects, the apparatus 700 may include a radio transceiver component 714. A stand alone receiver and/or stand alone transmitter may be used in lieu of or in conjunction with the transceiver 714. In the alternative, or in addition, the apparatus 700 may include multiple transceivers or transmitter/receiver pairs, which may be used to transmit and receive on different carriers. The apparatus 700 may optionally include a component for storing information, such as, for example, a memory device/component 716. The computer readable medium or the memory component 716 may be operatively coupled to the other components of the apparatus 700 via the bus 712 or the like. The memory component 716 may be adapted to store computer readable instructions and data for performing the activity of the components 702-704, and subcomponents thereof, or the processor 710, or the methods disclosed herein. The memory component 716 may retain instructions for executing functions associated with the components 702-704. While shown as being external to the memory 716, it is to be understood that the components 702-704 can exist within the memory 716.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available non-transitory media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and Blu-ray™ disc where disks usually encode data magnetically, while “discs” customarily refer to media encoded optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and features disclosed herein.

What is claimed is:

1. A method for configuring open loop power control (OLPC) parameters for uplink communications in a cellular wireless network, the method comprising:
determining, by a cell, an estimated number of neighbor cells deployed within radio range of the cell; and
configuring OLPC parameters for uplink communications, based on the estimated number of neighbor cells.

2. The method of claim 1, wherein determining the estimated number of neighbor cells comprises measuring respective signal strengths of the neighbor cells using a network listen functionality.

3. The method of claim 1, further comprising selecting at least two OLPC intermediate parameters Pₒ and α from a data table, based on the estimated number of neighbor cells.

4. The method of claim 3, further comprising determining a path loss statistic based on one or more UE measurement reports each indicating a path loss of a UE to at least one of the cell or one of the neighbor cells.

5. The method of claim 4, further comprising selecting the OLPC parameters further based on the path loss statistic and the OLPC intermediate parameters Pₒ and α.

6. The method of claim 1, further comprising adapting the OLPC parameters based on at least one of a UE power headroom report or overload indicator received from the neighbor cells.

7. The method of claim 1, further comprising determining whether to change an OLPC parameter based at least in part on a change in an estimated deployment density of the neighbor cells in a geographical neighborhood of the cell.

8. The method of claim 1, wherein the cell is a small cell.

9. The method of claim 1, wherein the neighbor cells comprise small cells.

10. An apparatus for wireless communication, the apparatus comprising:
means for determining an estimated number of neighbor cells deployed within radio range of a cell; and
means for configuring OLPC parameters for uplink communications, based on the estimated number of neighbor cells.

11. An apparatus for wireless communication, comprising:
at least one processor configured for determining an estimated number of neighbor cells deployed within radio range of a cell, and configuring OLPC parameters for uplink communications, based on the estimated number of neighbor cells; and
a memory coupled to the at least one processor for storing data.

12. The apparatus of claim 11, wherein the processor is further configured for determining the estimated number of neighbor cells at least in part by measuring respective signal strengths of the neighbor cells using a network listen functionality.

13. The apparatus of claim 11, wherein the processor is further configured for selecting at least two OLPC intermediate parameters Pₒ and α from a data table, based on the estimated number of neighbor cells.

14. The apparatus of claim 13, wherein the processor is further configured for determining a path loss statistic based on one or more UE measurement reports each indicating a path loss of a UE to at least one of the cell or one of the neighbor cells.

15. The apparatus of claim 14, wherein the processor is further configured for selecting the OLPC parameters further based on the path loss statistic and the OLPC intermediate parameters Pₒ and α.

16. The apparatus of claim 11, wherein the processor is further configured for adapting the OLPC parameters based on at least one of a UE power headroom report or overload indicator received from the neighbor cells.

17. The apparatus of claim 11, wherein the processor is further configured for determining whether to change an OLPC parameter based at least in part on a change in estimated deployment density of the neighbor cells in a geographical neighborhood of the cell.

18. The apparatus of claim 11, wherein the processor is further configured for operating the cell comprising a small cell.

19. The apparatus of claim 11, wherein the processor is further configured for determining the estimated number of neighbor cells comprising small cells.

20. A non-transitory computer-readable medium holding instructions, that when executed by a processor, cause a computer to:
determine an estimated number of neighbor cells deployed within radio range of a cell; and
configure OLPC parameters for uplink communications, based on the estimated number of neighbor cells.

21. The non-transitory computer-readable medium of claim 20, holding further instructions for determining the estimated number of neighbor cells at least in part by measuring respective signal strengths of the neighbor cells using a network listen functionality.

22. The non-transitory computer-readable medium of claim 20, holding further instructions for selecting at least two OLPC intermediate parameters Pₒ and a from a data table, based on the estimated number of neighbor cells.

23. The non-transitory computer-readable medium of claim 22, holding further instructions for determining a path loss statistic based on one or more UE measurement reports each indicating a path loss of a UE to at least one of the cell or one of the neighbor cells.

24. The non-transitory computer-readable medium of claim 23, holding further instructions for selecting the OLPC parameters further based on the path loss statistic and the OLPC intermediate parameters Pₒ and α.

25. The non-transitory computer-readable medium of claim 20, holding further instructions for determining whether to change an OLPC parameter based at least in part on a change in estimated deployment density of the neighbor cells in a geographical neighborhood of the cell.

26. The non-transitory computer-readable medium of claim 20, holding further instructions for adapting the OLPC parameters based on at least one of a UE power headroom report or overload indicator received from the neighbor cells.
